(19) United States
(12) Patent Application Publication
(10) Pub. No.: US 2026/0037379 A1
(43) Pub. Date: Feb. 5, 2026

(54) DESTINATION BASED MEDIA MANAGEMENT OPERATION

(71) Applicant: Micron Technology, Inc., Boise, ID (US)

(72) Inventors: Byron D. Harris, Mead, CO (US); Noorshaheen Mavungal Noorudheen, Longmont, CO (US); Paul Roger Stonelake, Kihei, HI (US)

(21) Appl. No.: 19/280,819

(22) Filed: Jul. 25, 2025

Related U.S. Application Data
(60) Provisional application No. 63/677,779, filed on Jul. 31, 2024.

(51) Int. Cl. G06F 11/10; G06F 11/20

(52) U.S. Cl. CPC G06F 11/1088; G06F 11/108; G06F 11/2053

(57) ABSTRACT

A destination block stripe is selected from a plurality of second block stripes of a second number of bits per cell cache storage for the media management operation responsive to initiating a media management operation. One or more first block stripes is selected from a plurality of first block stripes of a first number of bits per cell cache based on an occupancy criterion as a set of source block stripes for the media management operation. The second number of bits per cell is greater than the first number of bits per cell. The media management operation is performed. The media management operation relocates valid data from the set of source block stripes to the destination block stripe.

### RELATED APPLICATIONS

This application claims the benefit of U.S. Provisional Patent Application No. 63/677,779, filed Jul. 31, 2024, which is incorporated by reference herein.

### TECHNICAL FIELD

Embodiments of the disclosure relate generally to memory sub-systems, and more specifically, relate to destination-based media management operation.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with some embodiments of the present disclosure.

FIG. 1B illustrates a block diagram of a memory device in communication with a memory sub-system in accordance with some embodiments of the present disclosure.

FIG. 2 illustrates an example memory sub-system with destination based media management in accordance with some embodiment of the present disclosure.

FIG. 3 is a flow diagram of an example method of performing a destination-based media management operation in accordance with some embodiments of the present disclosure.

FIG. 4 is an illustrative example of destination based media management in accordance with some embodiment of the present disclosure.

FIG. 5 is an illustrative example of destination based media management in accordance with some embodiment of the present disclosure.

FIG. 6 is a block diagram of an example computer system in which embodiments of the present disclosure may operate.

### DETAILED DESCRIPTION

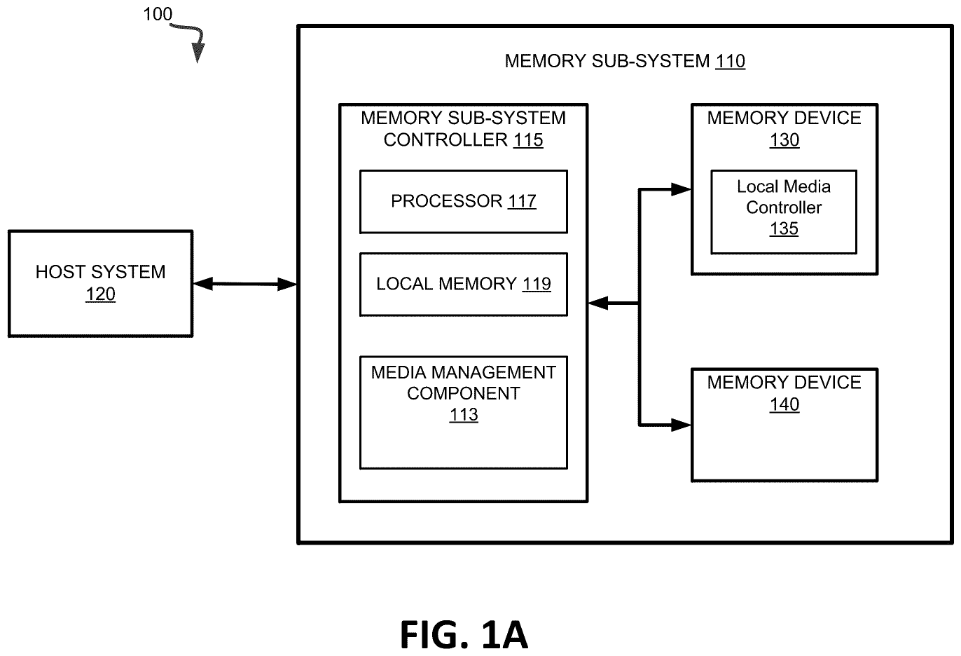

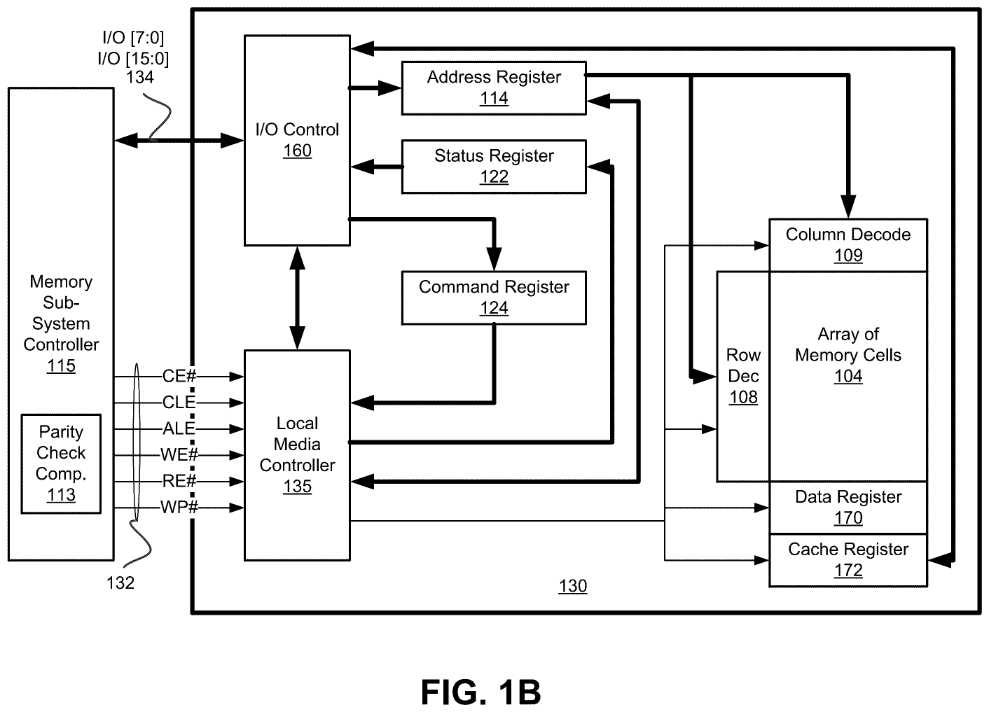

Aspects of the present disclosure are directed to destination-based media management operation. A memory sub-system can be a storage device, a memory module, or a combination of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1A. A non-volatile memory device is a package of one or more dies. Each die can includes of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types.

A die is also hereinafter referred to as a logical unit (LUN). A LUN can contain one or more planes. A memory sub-system can use a striping scheme to treat various sets of data as units when performing data operations (e.g., write, read, erase). A LUN stripe is a collection of planes that are treated as one unit when writing, reading, or erasing data. Each plane in a LUN stripe can carry out the same operation, in parallel, of all the other planes in the LUN stripe. A block stripe is a collection of blocks, one from each plane in a LUN stripe, which are treated as a unit. The blocks in a block stripe have the same block identifier (e.g., block number) in their respective planes.

A memory cell can be programmed (written to) by applying a certain voltage to the memory cell, which results in an electric charge being held by the memory cell. For example, a voltage signal V_{CG} that can be applied to a control electrode of the cell to open the cell to the flow of electric current across the cell, between a source electrode and a drain electrode. More specifically, for each individual memory cell (having a charge Q stored thereon) there can be a threshold control gate voltage V_{T} (herein also referred to as the “threshold voltage” or simply as “threshold”) such that the source-drain electric current is low for the control gate voltage (V_{CG}) being below the threshold voltage, V_{CG}<V_{T}. The current increases substantially once the control gate voltage has exceeded the threshold voltage, V_{CG}>V_{T}. Because the actual geometry of the electrodes and gates varies from cell to cell, the threshold voltages can be different even for cells implemented on the same die. The memory cells can, therefore, be characterized by a distribution P of the threshold voltages, P(Q, V_{T})=dW/dV_{T}, where dW represents the probability that any given cell has its threshold voltage within the interval [V_{T}, V_{T}+dV_{T}] when charge Q is placed on the cell.

A memory device can have distributions P(Q, V_{T}) that are narrow compared with the working range of control voltages tolerated by the cells of the device. Accordingly, multiple non-overlapping distributions P(Q_{K}, V_{T}) (“valleys”) can be fit into the working range allowing for storage and reliable detection of multiple values of the charge Qₖ, k=1, 2, 3. . . . The distributions (valleys) are interspersed with voltage intervals (“valley margins”) where none (or very few) of the memory cells of the device have their threshold voltages. Such valley margins can, therefore, be used to separate various charge states Qₖ—the logical state of the cell can be determined by detecting, during a read operation, between which two valley margins the respective threshold voltage V_{T} of the cell resides. This effectively allows a single memory cell to store multiple bits of information: a memory cell operated with 2N-1 well-defined valley margins and 2N valleys is capable of reliably storing N bits of information. Specifically, the read operation can be performed by comparing the measured threshold voltage VT exhibited by the memory cell to one or more reference voltage levels corresponding to known valley margins (e.g., centers of the margins) of the memory device.

One type of memory cell (“cell”) is a single level cell (SLC), which stores 1 bit per cell and defines 2 logical states (“states”) (“1” or “L0” and “0” or “L1”) each corresponding to a respective V_{T} level. For example, the “1” state can be an erased state and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”) each corresponding to a respective V_{T} level. For example, the “11” state can be an erased state and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”) each corresponding to a respective V_{T} level. For example, the “111” state can be an erased state and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. Thus, an n-level cell can use 2ⁿ levels of charge to store n bits. A memory device can include one or more arrays of memory cells such as SLCs, MLCs, TLCs, QLCS, PLCs, etc. or any combination of such. For example, a memory device can include an SLC portion, and an MLC portion, a TLC portion, a QLC portion, or a PLC portion of memory cells.

Due to the phenomenon known as slow charge loss (SCL), the threshold voltage of a memory cell changes in time as the electric charge of the cell is degrading, which is referred to as “temporal voltage shift” (since the degrading electric charge causes the voltage distributions to shift along the voltage axis towards lower voltage levels). The threshold voltage is changing rapidly at first (immediately after the memory cell was programmed), and then slows down in an approximately logarithmic linear fashion with respect to the time elapsed since the cell programming event. Accordingly, failure to mitigate the temporal voltage shift caused by the slow charge loss can result in the increased bit error rate in read operations.

Some memory sub-systems, mitigates the temporal voltage shift by employing block family-based error avoidance (BFEA) strategies. The temporal voltage shift is selectively tracked for programmed blocks grouped by block families, and appropriate voltage offsets, which are based on block affiliation with a certain block family, are applied to the base read levels in order to perform read operations. “Block family” herein shall refer to a set of blocks that have been programmed within a specified time window and a specified temperature window. Since the time elapsed after programming and temperature are the main factors affecting the temporal voltage shift, all blocks and/or partitions within a single block family are presumed to exhibit similar distributions of threshold voltages in memory cells, and thus would require the same voltage offsets to be applied to the base read levels for read operations. “Base read level” herein shall refer to the initial threshold voltage level exhibited by the memory cell immediately after programming. In some implementations, base read levels can be stored in the metadata of the memory device.

Block families can be created asynchronously with respect to block programming events. In an illustrative example, a new block family can be created whenever a specified period of time (e.g., a predetermined number of minutes) has elapsed since creation of the last block family or the reference temperature of memory cells has changed by more than a specified threshold value. The memory sub-system controller can maintain an identifier of the active block family, which is associated with one or more blocks as they are being programmed.

Some memory sub-systems (e.g., SSDs) implement SLC caching for storing data. SLC caching utilizes SLC cache along with XLC storage. An XLC cell is a multiple level cell that stores more than one bit of state information per cell (e.g., MLC, TLC, QLC, PLC, as described above). SLC caching can be used to improve write speed since programming data on SLC cells is generally faster than programming data on XLC cells. Each of the SLC cache and the XLC storage includes a set of block stripes.

Initially, the incoming data is written to the SLC cache. The memory sub-system monitors the occupancy of the SLC cache. Once the amount of data in the SLC cache reaches a predetermined threshold, indicating that the SLC cache is nearing its capacity, a media management operation (e.g., folding or garbage collection) can be initiated to free up space in the SLC cache. Folding refers to a process of migrating valid data from a memory location to another memory location to free more space for new writes, for error avoidance, for wear leveling, and to restore parity protection in the event of an error. Garbage collection refers to a process of consolidating valid data from one memory location to another memory location.

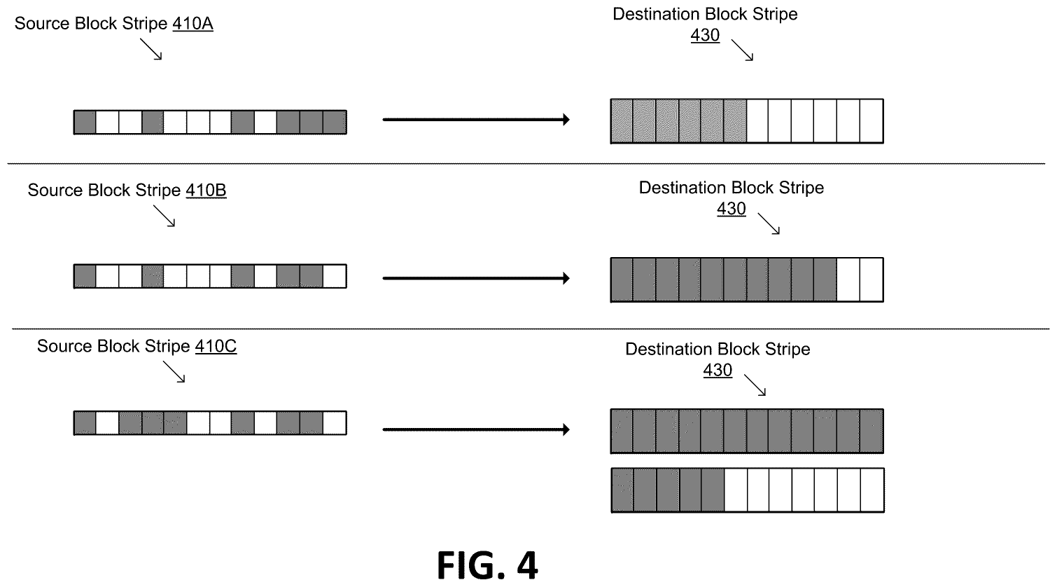

During the media management operation, valid data from a current block stripe of the SLC cache (e.g., a current source block stripe) is relocated into a current block stripe of the XLC storage (e.g., a current destination block stripe). For example, referring to FIG. 4, source block stripe 410A of the SLC cache contains both valid and invalid data. The media management operation identifies valid data within source block stripe 410A (e.g., shown as shaded or colored regions) and relocates it into destination block stripe 430 of the XLC storage, while discarding the invalid or stale data.

Once the folding of data from source block stripe 410A is complete, destination block stripe 430 may still contain unprogrammed (blank) regions. The media management operation continues folding by selecting a second source block stripe, such as source block stripe 410B. Valid data from source block stripe 410B is identified and relocated into the available regions of destination block stripe 430, continuing the process of incrementally filling destination block stripe 430 without unnecessary waste of storage capacity.

Following this, valid data from a third source block stripe, such as source block stripe 410C, is also folded into the remaining unprogrammed regions of the same destination block stripe 430. Through this iterative folding process across multiple source block stripes (source block stripe 410A, source block stripe 410B, and source block stripe 410C), the media management operation efficiently fills the destination block stripe 430 while simultaneously reclaiming space in the SLC cache.

However, due to SCL, the current destination block stripe (e.g., destination block stripe 430) may remain partially written for an extended period of time thus triggering a scan operation for adjusting the threshold voltage threshold. However, some memory sub-systems may not support BFEA strategies due to their added complexity to the memory sub-system. Additionally, some memory sub-system may not support reading from partially programmed partially written block stripe of the XLC storage because they result in incomplete or inconsistent data retrieval, which can lead to data corruption or errors.

Aspects of the present disclosure address the above and other deficiencies by providing a memory sub-system that implements destination-based media management operations as a mechanism of SCL mitigation. A memory sub-system described herein can include a SLC cache and a XLC storage. The SLC cache includes multiple block stripes (SLC block stripes). Incoming data is written to an SLC block stripe of the multiple SLC block stripes. Once the SLC cache reaches at least a predefined portion of its capacity, the memory sub-system initiates the media management operations (e.g., folding or garbage collection). Accordingly, the memory sub-system selects, from multiple block stripes of the XLC storage (XLC block stripes), an XLC block stripe to be used by the media management operation as a destination block stripe. The memory sub-system, based on the capacity of the XLC block stripe, selects one or more SLC block stripes (a set of source block stripes) that, collectively, provide valid data that satisfies (e.g., is equal to or greater than) the capacity of the XLC block stripe. Thus, the set of source block stripes provides enough valid data to avoid a partially written destination block stripe.

After selecting the destination block stripe and the set of source block stripes, the memory sub-system performs the media management operations using the destination block stripe and the set of source block stripes. More specifically, the media management operation reads valid data from each source block stripe of the set of source block stripes and writes the valid data to the destination block stripe. The memory sub-system terminates the media management operation upon fully programming the destination block. Thus, the media management operation performs a continuous stream of programming operations without any significant time delay between consecutive programming operations eliminating the need for BFEA strategies.

Advantages of the present disclosure include, but are not limited to, improved memory device performance and reduced memory device complexity. For example, implementations described herein can improve data retention, and therefore decrease error rates.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCle or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a media management component 113 that can, during a media management operation, select a block stripe from a storage portion of the memory device 130 and/or 140 to be fully programmed with valid data from one or more block stripes from a cache portion of the memory device 130 and/or 140. In some embodiments, the memory sub-system controller 115 includes at least a portion of the media management component 113. In some embodiments, the media management component 113 is part of the host system 120, an application, or an operating system. In other embodiments, local media controller 135 includes at least a portion of media management component 113 and is configured to perform the functionality described herein.

The media management component 113 can, in response to initiating a media management operation, select a first block stripe available for programming from a plurality of block stripes of a portion of memory device 130 and/or 140 designated as storage (e.g., a destination block stripe). Each cell of the portion of memory device 130 and/or 140 designated as storage may store multiple bits per cell (e.g., MLC storage, TLC storage, QLC storage, or PLC storage).

The media management component 113, based on a capacity of the destination block stripe, selects one or more block stripes from a plurality of block stripes (e.g., a set of source block stripes) of a portion of memory device 130 and/or 140 designated as cache. Each cell of the cache may store less bits per cell than the storage (e.g., SLC cache). The media management component 113 maintains a valid codeword count used to track a number of valid codewords included in the set of source block stripes. The media management component 113, after selecting a block stripe of the plurality of block stripes of the cache, obtains a number of valid codewords of the selected block stripe of the cache. The media management component 113 adds the number of valid codewords of the selected block stripe of the cache to the valid codeword count. The media management component 113 includes the selected block stripe of the cache into the set of source block stripes.

The media management component 113 determines whether the valid codeword count satisfies an occupancy criterion. The occupancy criterion is satisfied if the valid codeword count meets or exceeds an occupancy threshold. The occupancy threshold is substantially equivalent to the capacity of the destination block stripe. In other words, the occupancy threshold is equivalent to a number of codewords that can be programmed to the destination block stripe. The media management component 113, if the valid codeword count does not satisfy the occupancy criterion, repeats the process with a subsequent block stripe of the plurality of block stripes of the cache (e.g., obtaining a number of valid codewords, adding the number of valid codewords to the valid codeword count, and including the subsequent block stripe into the set of source block stripes).

The media management component 113, if the valid codeword count does satisfies the occupancy criterion, performs the media management operation with the set of source block stripes and the destination block stripe. As previously described, the media management operation may be folding or garbage collection. For each source block stripe of the set of source block stripes, the media management component 113 reads the valid data from a respective source block stripe and writes the valid data into the destination block stripe. Once the valid data of the respective source block stripe is fully written to the destination block stripe, the media management component 113 may erase the respective source block stripe. In some embodiments, the valid data of the respective source block stripe may not be fully written to the destination block stripe. Accordingly, the media management component 113 may terminate the media management operation and not erase the valid data of the respective source block stripe.

In some embodiments, a program erase cycle (PEC) count is maintained for each block stripe of the plurality of block stripes of the storage. Alternatively, in some embodiments, the plurality of block stripes of the cache may be ordered by when each block stripe of the plurality of block stripes of the cache was programmed (e.g., from block stripe programmed first to block stripe programmed last or first in, first out). The media management component 113 determines whether the PEC count of the destination block stripe exceeds a predefined threshold indicating that the destination block stripe is near end of life.

If the PEC count of the destination block stripe exceeds the predefined threshold, the media management component 113 selects, sequentially from a last block stripe of the plurality of block stripes of the cache to a first block stripe of the plurality of block stripes of the cache, the one or more block stripes from the plurality of block stripes as the set of source block stripes. Thus, when performing the media management operation, data from the set of source block stripes which have not been programmed for a while are relocated to a destination block stripe that is near end of life.

If the PEC count of the destination block stripe does not exceed the predefined threshold, the media management component 113 selects, sequentially from the first block stripe of the plurality of block stripes of the cache to the last block stripe of the plurality of block stripes of the cache, the one or more block stripes from the plurality of block stripes as the set of source block stripes. Thus, when performing the media management operation, data from the set of source block stripes which were recently programmed are relocated to a destination block stripe that is not near end of life.

Depending on the embodiment, the plurality of block stripes of the storage may be ordered by the PEC count (e.g., from block stripe with lowest PEC count to block stripe with highest PEC count). Thus, rather than the media management component 113 selecting the first block stripe from the plurality of block stripes of the storage available for programming irrespective of the number of PECs, the first block stripe from the plurality of block stripes of the storage is the block stripe from the plurality of block stripes of the storage having the lowest number of PECs. As a result, the media management component 113 can even wear the storage.

Depending on the embodiment, the plurality of block stripes of the cache may be ordered using a number of valid codewords for each block stripe of the plurality of block stripes of the cache (e.g., from a block stripe having the lowest number of valid codewords to a block stripe having the largest number of valid codewords). Thus, as the media management component 113 selecting, sequentially from first to last of the plurality of block stripes of the cache, the one or more block stripes from the plurality of block stripes as the set of source block stripes a maximum number of block stripes from the plurality of block stripes of the cache is selected for the set of source block stripes. Further details with regards to the operations of the media management component 113 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer of the memory device 130. A page buffer may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 236 and outputs data to the memory sub-system controller 115 over I/O bus 236.

For example, the commands may be received over input/output (I/O) pins [7:0] of I/O bus 236 at I/O control circuitry 160 and may then be written into command register 124. The addresses may be received over input/output (I/O) pins [7:0] of I/O bus 236 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

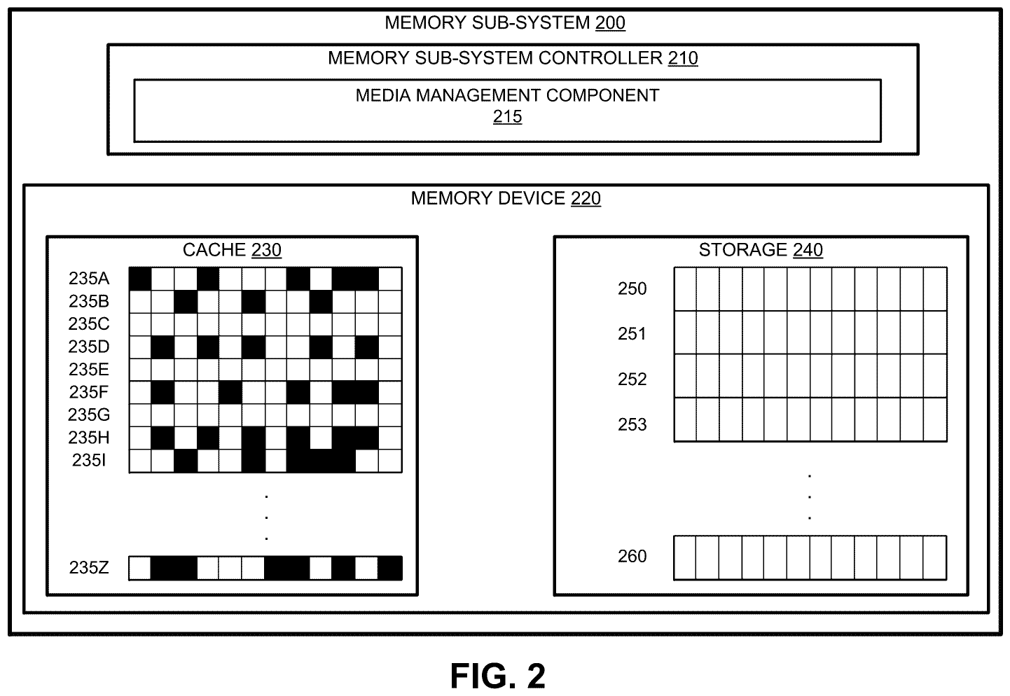

FIG. 2 illustrates an example memory sub-system 200, in accordance with some embodiments of the present disclosure. Memory sub-system 200, similar to memory sub-system 110 of FIG. 1A, includes a memory sub-system controller 210 (similar to memory sub-system controller 115 of FIG. 1A), and a memory device 220 (similar to memory device 130 and/or 140 of FIG. 1A). Memory sub-system controller 210 includes a media management component 215 (e.g., media management component 113 of FIG. 1A).

Memory device 220 includes a portion designated as cache 230 and a portion designated as storage 240. Each cell of cache 230 may store, for example, a single bit per cell also referred to as a single level cell (SLC). Each cell of storage 240 may store, for example, three bits per cell also referred to as a triple level cell (TLC). Cache 230 includes a plurality of cache block stripes 235A-Z and storage 240 includes a plurality of storage block stripes 250-260. As previously described, cache 230 is written with incoming data (e.g., a cache block stripe of the plurality of cache block stripes 235A-Z). Once cache 230 is near capacity, the media management component 215 initiates a media management operation (e.g., folding or garbage collection) to relocate valid data (shown in black) from cache 230 (e.g., one or more cache block stripe of the plurality of cache block stripes 235A-Z) to storage 240 (e.g., a storage block stripe of the plurality of storage block stripes 250-260) to free up space in cache 230.

More specifically, as previously described, the media management component 215, in response to determining that cache 230 is near capacity (e.g., reaching a predetermined threshold), initiates the media management operation. Upon initiating the media management operation, the media management component 215 selects a storage block stripe of the plurality of storage block stripes 250-260 as a destination block stripe for the media management operation.

In some embodiments, the media management component 215 selects the storage block stripe of the plurality of storage block stripes 250-260 to be used as the destination block stripe by selecting a first storage block stripe of the plurality of storage block stripes 250-260 (e.g., ordered by storage block stripe identifier) available for programming. In some embodiments, the plurality of storage block stripes 250-260 may be ordered by PECs (e.g., from a storage block stripe having a lowest number of PECs to a storage block stripe having a largest number of PECs). Thus, the first storage block stripe of the plurality of storage block stripes 250-260 available for programming is the storage block stripe with the lowest number of PECs available for programming.

Once the destination block stripe is selected for the media management operation, the media management component 215 selects one or more cache block stripes of the plurality of cache block stripes 235A-Z to be used as a set of source block stripes. For example, the media management component 215 selects the one or more cache block stripes of the plurality of cache block stripes 235A-Z to be used as a set of source block stripes by identifying the one or more cache block stripes of the plurality of cache block stripes 235A-Z that contain enough valid data to fully program the destination block.

As previously described, the media management component 215 maintains a valid codeword count used to track a number of valid codewords of the one or more cache block stripes of the plurality of cache block stripes 235A-Z to be used as a set of source block stripes. In some embodiments, the media management component 215, starting from a first cache block stripe of the plurality of cache block stripes 235A-Z (e.g., ordered by cache block stripe identifier), selects a cache block stripe of the plurality of cache block stripes 235A-Z and obtains a number of valid codewords for the selected cache block stripe. The media management component 215 adds the number of valid codewords of the selected cache block stripe to the valid codeword count. The media management component 215 includes the selected cache block stripe into the set of source block stripes.

The media management component 215 determines whether the valid codeword count satisfies an occupancy criterion. The occupancy criterion is satisfied if the valid codeword count meets or exceeds an occupancy threshold. The occupancy threshold is substantially equivalent to the capacity of the destination block stripe. If the valid codeword count does not satisfy the occupancy criterion, media management component 215 repeats the process with a subsequent cache block stripe of the plurality of cache block stripes 235A-Z. Otherwise, the media management component 215 performs the media management operation with the set of source block stripes and the destination block stripe.

Depending on the embodiment, the plurality of cache block stripes 235A-Z may be ordered by number of valid codewords (e.g., from a cache block stripe having the lowest number of valid codewords to a cache block stripe having the largest number of valid codewords). Thus, a maximum number of cache block stripes from the plurality of cache block stripes 235A-Z is selected for the set of source block stripes.

Depending on the embodiment, the plurality of cache block stripes 235A-Z may be ordered by when each cache block stripe was programmed (e.g., from a cache block stripe programmed first to a cache block stripe programmed last). Accordingly, the media management component 215, when selecting the set of source block stripes, determines whether the number of PECs of the destination block stripes exceeds a predefined threshold indicating that the destination block stripe is near end of life. If the number of PECs of the destination block stripes exceeds the predefined threshold, the media management component 215 selects, starting from a first cache block stripes of the plurality of cache block stripes 235A-Z to a last cache block stripes of the plurality of cache block stripes 235A-Z, the one or more cache block stripes of the plurality of cache block stripes 235A-Z to be used as a set of source block stripes. Otherwise, the media management component 215 selects, starting from the last cache block stripes of the plurality of cache block stripes 235A-Z to the first cache block stripes of the plurality of cache block stripes 235A-Z, the one or more cache block stripes of the plurality of cache block stripes 235A-Z to be used as a set of source block stripes.

Once the set of source block stripes and the destination block stripe is selected, the media management component 215, performs the media management operation. As previously described, for each source block stripe of the set of source block stripes, the media management component 215 reads the valid data from a respective source block stripe (shown in black) and writes the valid data into the destination block stripe. Once the valid data of the respective source block stripe is fully written to the destination block stripe, the media management component 113 may erase the respective source block stripe. Once the destination block stripe is fully written, the media management component 215 terminates the media management operation. In some embodiments, the destination block stripe may be fully written, and at least one or more of the set of source block stripes contains valid data not written to the destination block. The at least one or more of the set of source block stripes containing valid data not written to the destination block is not erased, and the media management operation is terminated.

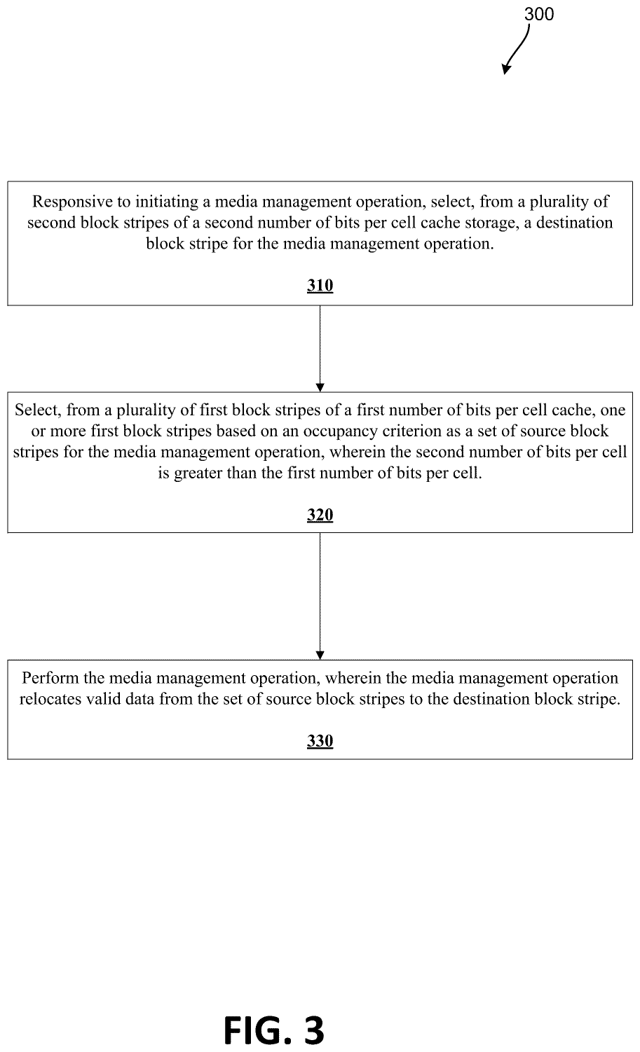

FIG. 3 is a flow diagram of an example method 300 of performing destination-based media management operation, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the media management component 113 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, responsive to initiating a media management operation, the processing logic selects, from a plurality of second block stripes of a second number of bits per cell cache storage, a destination block stripe for the media management operation. As previously described, the media management operation may be folding or garbage collection. In some embodiments, the processing logic selects, as the destination block stripe, a first second block stripe of the plurality of second block stripes. As previously described, the plurality of second block stripes may be ordered by the program erase cycle (PEC) count (e.g., from block stripe with lowest PEC count to block stripe with highest PEC count). Thus, selecting the first second block stripe of the plurality of second block stripes refers to the second block stripe of the plurality of second block stripes having a lowest number of PECs.

At operation 320, the processing logic selects, from a plurality of first block stripes of a first number of bits per cell cache, one or more first block stripes based on an occupancy criterion as a set of source block stripes for the media management operation. The second number of bits per cell may be greater than the first number of bits per cell. As previously described, the first number of bits per cell may be SLC and the second number of bits per cell may be TLC.

In some embodiments, with each selection of a first block stripe to be included in the set of source block stripes, the processing logic maintains a valid codeword count for the set of source block stripes. In particular, for each first block stripe selected, the processing logic determines whether the valid codeword count satisfies the occupancy criterion. In some embodiments, the occupancy criterion may be satisfied if a valid codeword count is equal to or exceeds an occupancy threshold (e.g., a number of codewords that can be programmed to the destination block stripe). Responsive to determining that the valid codeword count does not satisfy the occupancy criterion, the processing logic includes each selected first block stripe in the set of source block stripes. Thereafter, the processing logic increments the valid codeword count by a number of valid codewords in each selected first block stripe.

Depending on the embodiment, the plurality of first block stripes is chronologically ordered from a first block stripe programmed first to a first block stripe programmed last. In other words, as previously described, the plurality of first block stripes may be ordered by when each block stripe of the plurality of first block stripe was programmed (e.g., from block stripe programmed first to block stripe programmed last). Accordingly, based on PEC count of the destination block stripe, the set of source block stripes are selected sequentially starting from a first block stripe ordered first in the plurality of first block stripes (e.g., PEC count exceed predefined threshold) or a first block stripe ordered last in the plurality of first block stripes (e.g., PEC count does not exceed predefined threshold).

Depending on the embodiment, the plurality of first block stripes is ordered from a first block stripe having the lowest number of valid codewords to a first block stripe having the largest number of valid codewords. In other words, as previously described, the plurality of first block stripes may be ordered using a number of valid codewords for each first block stripe of the plurality of first block stripes (e.g., from a first block stripe having the lowest number of valid codewords to a first block stripe having the largest number of valid codewords). Accordingly, the set of source block stripes are selected sequentially starting from a first block stripe ordered first in the plurality of first block stripes (e.g., the first block stripe having the lowest number of valid codewords). Thus, a maximum number of first block stripes from the plurality of first block stripes are selected for the set of source block stripes.

At operation 330, the processing logic performs the media management operation. The media management operation relocates valid data from the set of source block stripes to the destination block stripe. As previously described, for each source block stripe of the set of source block stripes, the processing logic reads the valid data from a respective source block stripe and writes the valid data into the destination block stripe. Once the valid data of the respective source block stripe is fully written to the destination block stripe, the processing logic may erase the respective source block stripe. In some embodiments, the set of source block stripes may not contain enough valid data for the destination block stripe due to host invalidation or deallocation. Accordingly, the remaining portion of the destination block stripe may be padded with data (e.g., zeros or a known pattern). The processing logic may determine that the destination block is fully written and terminate the media management operation. In some embodiments, upon termination of the media management operation at least one source block stripe of the set of source block stripes may include valid data that was not written to the destination block stripe. Thus, the at least one source block stripe is not erased.

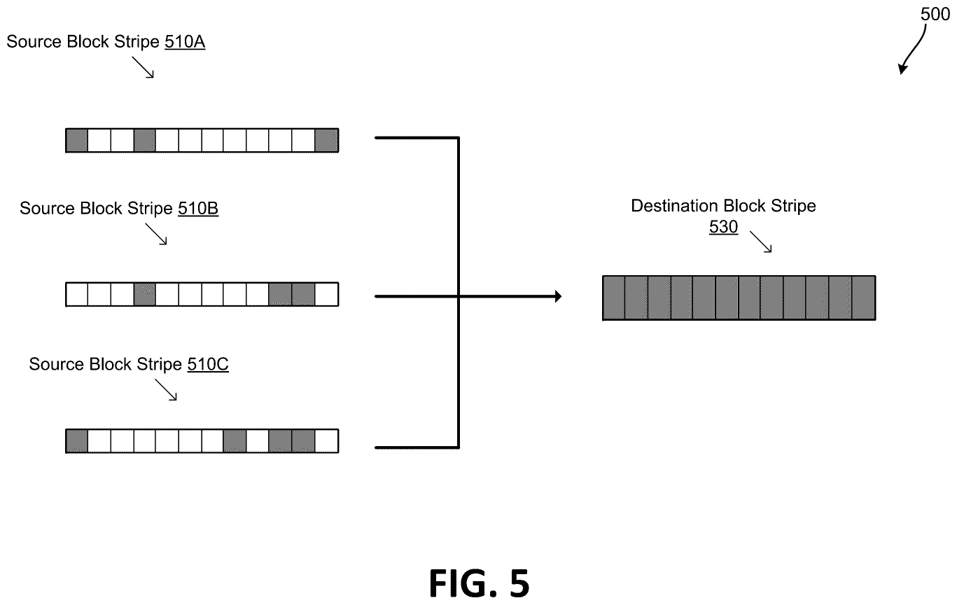

FIG. 5 is an illustrative example of destination based media management 500 in accordance with some embodiment of the present disclosure. As previously described, responsive to initiating a media management operation, a destination block stripe (e.g., destination block stripe 530) is selected for the media management operation. As previously described, a plurality of block stripes is selected based on an occupancy criterion as a set of source block stripes for the media management operation (e.g., source block stripes 510A-C).

During performance of the media management operation, valid data is relocated from the set of source block stripes (e.g., source block stripes 510A-C) to the destination block stripe (e.g., destination block stripe 530). As previously described, for each source block stripe of the set of source block stripes, valid data is read from a respective source block stripe and writes the valid data into the destination block stripe. Once the valid data of the respective source block stripe is fully written to the destination block stripe, the respective source block stripe is erased. Once the destination block stripe is fully written, the media management operation is terminated.

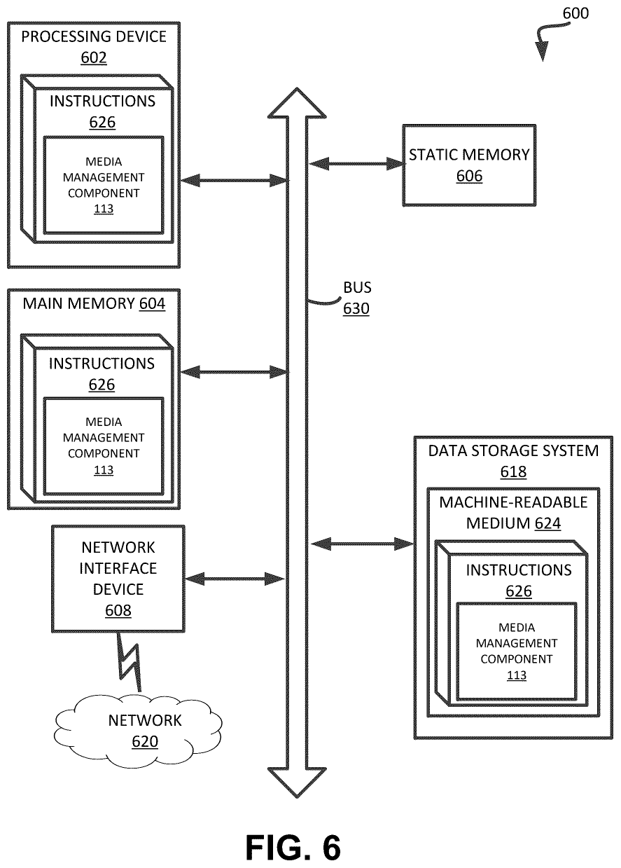

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the media management component 113 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1A.

In one embodiment, the instructions 626 include instructions to implement functionality corresponding to a media management component (e.g., the media management component 113 of FIG. 1A). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory sub-system comprising:
a cache comprising a plurality of a first number of bits per cell memory cells associated with a plurality of first block stripes;
a storage comprising a plurality of a second number of bits per cell memory cells associated with a plurality of second block stripes, wherein the second number of bits per cell is greater than the first number of bits per cell; and
a processing device, operatively coupled with the cache and the storage, to perform operations comprising:
responsive to initiating a media management operation, selecting, from the plurality of second block stripes, a second block stripe as a destination block stripe for the media management operation;
selecting, from the plurality of the first block stripes, one or more first block stripes satisfying an occupancy criterion as a set of source block stripes for the media management operation; and
performing the media management operation, wherein the media management operation relocates valid data from the set of source block stripes to the destination block stripe.

2. The system of claim 1, wherein selecting the destination block stripe comprises:
selecting, from the plurality of second block stripes, a second block stripe having a lowest number of program erase cycles (PECs) as the destination block stripe.

3. The system of claim 1, wherein selecting the destination block stripe comprises:
selecting a first second block stripe of the plurality of second block stripes as the destination block stripe.

4. The system of claim 1, wherein selecting the set of source block stripes comprises:
maintaining a valid codeword count;
for each first block stripe of the plurality of first block stripes, determining whether the valid codeword count satisfies the occupancy criterion; and
responsive to determining that the valid codeword count does not satisfy the occupancy criterion, including a respective first block stripe in the set of source block stripes and incrementing the valid codeword count by a number of valid codewords in the respective first block stripe.

5. The system of claim 1, wherein the plurality of first block stripes is chronologically ordered from a first block stripe programmed first to a first block stripe programmed last.

6. The system of claim 1, wherein the plurality of first block stripes is ordered from a first block stripe having a lowest number of valid codewords to a first block stripe having a largest number of valid codewords.

7. The system of claim 1, wherein the occupancy criterion is satisfied if a valid codeword count is equal to or exceeds an occupancy threshold.

8. The system of claim 7, wherein the occupancy threshold corresponds to a number of codewords to be programmed to the destination block stripe.

9. A method comprising:
responsive to initiating a media management operation, selecting, from the plurality of second block stripes, a second block stripe as a destination block stripe for the media management operation;
selecting, from the plurality of the first block stripes, one or more first block stripes satisfying an occupancy criterion as a set of source block stripes for the media management operation; and
performing the media management operation, wherein the media management operation relocates valid data from the set of source block stripes to the destination block stripe.

10. The method of claim 9, wherein selecting the destination block stripe comprises:
selecting, from the plurality of second block stripes, a second block stripe having a lowest number of program erase cycles (PECs) as the destination block stripe.

11. The method of claim 9, wherein selecting the destination block stripe comprises:
selecting a first second block stripe of the plurality of second block stripes as the destination block stripe.

12. The method of claim 9, wherein selecting the set of source block stripes comprises:
maintaining a valid codeword count;
for each first block stripe of the plurality of first block stripes, determining whether the valid codeword count satisfies the occupancy criterion; and
responsive to determining that the valid codeword count does not satisfy the occupancy criterion, including a respective first block stripe in the set of source block stripes and incrementing the valid codeword count by a number of valid codewords in the respective first block stripe.

13. The method of claim 9, wherein the plurality of first block stripes is chronologically ordered from a first block stripe programmed first to a first block stripe programmed last.

14. The method of claim 9, wherein the plurality of first block stripes is ordered from a first block stripe having a lowest number of valid codewords to a first block stripe having a largest number of valid codewords.

15. The method of claim 9, wherein the occupancy criterion is satisfied if a valid codeword count is equal to or exceeds an occupancy threshold.

16. The method of claim 15, wherein the occupancy threshold corresponds to a number of codewords to be programmed to the destination block stripe.

17. A non-transitory computer-readable storage medium comprising instructions that, when executed by a processing device, cause the processing device to perform operations comprising:
responsive to initiating a media management operation, selecting, from the plurality of second block stripes, a second block stripe as a destination block stripe for the media management operation;
selecting, from the plurality of the first block stripes, one or more first block stripes satisfying an occupancy criterion as a set of source block stripes for the media management operation; and
performing the media management operation, wherein the media management operation relocates valid data from the set of source block stripes to the destination block stripe.

18. The non-transitory computer-readable storage medium of claim 17, wherein selecting the destination block stripe comprises:
selecting, from the plurality of second block stripes, a second block stripe having a lowest number of program erase cycles (PECs) as the destination block stripe.

19. The non-transitory computer-readable storage medium of claim 17, wherein selecting the set of source block stripes comprises:
maintaining a valid codeword count;
for each first block stripe of the plurality of first block stripes, determining whether the valid codeword count satisfies the occupancy criterion; and
responsive to determining that the valid codeword count does not satisfy the occupancy criterion, including a respective first block stripe in the set of source block stripes and incrementing the valid codeword count by a number of valid codewords in the respective first block stripe.

20. The non-transitory computer-readable storage medium of claim 17, wherein the occupancy criterion is satisfied if a valid codeword count is equal to or exceeds a number of codewords to be programmed to the destination block stripe.
